(19) United States
(12) Patent Application Publication
(10) Pub. No.: US 2019/0197168 A1
(43) Pub. Date: Jun. 27, 2019

(54) CONTEXTUAL ENGINE FOR DATA VISUALIZATION

(71) Applicant: PayPal, Inc., San Jose, CA (US)

(72) Inventors: Gregory Sylvester, II, San Jose, CA (US); Rahul Shukla, Bangalore (IN); Chetan Nadgire, Mountain View, CA (US); Gulshan Ramesh Chand, San Jose, CA (US)

(21) Appl. No.: 15/900,839

(22) Filed: Feb. 21, 2018

(30) Foreign Application Priority Data
Dec. 27, 2017 (IN) 201741046760

(51) Int. Cl. G06F 17/30

(52) U.S. Cl. CPC G06F 17/30554; G06F 2216/03; G06F 17/30539; G06F 17/3053

(57) ABSTRACT

Systems, methods, and computer program products are disclosed for providing a contextual recommendation corresponding to a visualization. An example method includes ingesting a data set from or more data sources, including applying rules that transform the data set into a standardized format. The subsets of the ingested data set are assigned based on a determined variable into population coverage ranges that correspond to statistical distributions of the determined variable. Distribution analysis is performed across at least one of the population coverage ranges to identify a distribution data set corresponding to the determined variable. The distribution set is parsed to identify a context recommendation. The identified context recommendation is mapped to a tag corresponding to the determined variable, and a visualization type corresponding to the distribution data set. The tag, the context recommendation, and the visualization type are ranked, and a rendered visualization is then provided, to a graphical user interface, corresponding to the ranked tag, the ranked context recommendation, and the ranked visualization type.

### RELATED APPLICATIONS(S)

The present application is related to and claims priority from the co-pending India Patent Application titled “Contextual Engine for Data Visualization,” Serial Number 201741046760, filed on Dec. 27, 2017, which is hereby incorporated by reference in its entirety.

### BACKGROUND

The present disclosure generally relates to the data processing and data mining fields, and more particularly to contextual data analytics.

Data mining is a field of computer science that relates to extracting patterns and other knowledge from large amounts of data. One source of this data is transaction history data that includes logs corresponding to electronic transactions. Transaction history data may be stored in large storage repositories, which may be referred to as data warehouses or data stores. These storage repositories may include vast quantities of transaction history data. Other sources of data mining include user browsing histories and surveys.

Data mining of transaction history data has been useful to provide valuable insights in the areas of product improvement, marketing, customer segmentation, fraud detection, and risk management.

### BRIEF DESCRIPTION OF THE DRAWINGS

The present embodiments may be better understood, and numerous objects, features, and advantages made apparent to those skilled in the art by referencing the accompanying drawings.

FIG. 1 is an organizational diagram illustrating a system that implements a contextual engine for data analytics, in accordance with various examples of the present disclosure.

FIG. 2 is a flow diagram illustrating a method for providing contextual data analytics, in accordance with various examples of the present disclosure.

FIG. 3 is a flow diagram illustrating a method for updating and applying context recommendation rules, in accordance with various examples of the present disclosure.

FIG. 4 is a diagram illustrating an example binomial frequency distribution generated for providing contextual data analytics, in accordance with various examples of the present disclosure.

FIG. 5 is a diagram illustrating an example binomial frequency distribution including contextualization, in accordance with various examples of the present disclosure.

FIG. 6 is a diagram illustrating an example binomial frequency distribution including contextualization, in accordance with various examples of the present disclosure.

FIG. 7 is an organizational diagram of a user device, in accordance with various examples of the present disclosure.

Examples of the present disclosure and their advantages are best understood by referring to the detailed description that follows.

### DETAILED DESCRIPTION

The description that follows includes exemplary systems, methods, techniques, instruction sequences and computer program products that embody techniques of the present inventive subject matter. However, it is understood that the described embodiments may be practiced without these specific details. The discussion below relates to insights and analytics, which can power decisions but are underutilized. Decisions based on traditional data analysis can require, for proper utilization, months or even years-worth of data. However, using a combination of methods discussed herein, it is possible to generate quick internal insights and analytics, and develop an external product utilizing the same data.

As a high-level overview, techniques are described herein to provide a graphical visualization of a data set, including contextual observations corresponding to the data set, which can be presented on a user interface, such as a monitor or other display. The visualization is dynamically generated by ingesting data from one or more data sources that are joined based on an input hypothesis. These data sources may store various types of data, such as transactions data, user history data, survey data, and so forth. Once the data is ingested, relationships between the data are determined using distribution analysis techniques that yield a variable determined to have a high propensity to effect the data. Based on the high propensity variable, the data is organized into subset population coverage ranges (e.g., if the variable is amount of transactions, the subsets may include population coverage ranges such as 0-10 transactions, 11-20 transactions, and so forth).

A context recommendation is determined by performing distribution analysis on the population coverage ranges. For example, a context recommendation may be an observation that marketing increased transactions for one population coverage range but not for another population coverage range. The context recommendation may include a generated observation based on the distribution analysis, such as to increase marketing corresponding to a particular population coverage range. Rules input by a user or determined from previous analysis are applied to determine an optimal visual representation of the ingested data that is organized into the population coverage ranges. For example, if the data relates to time information, a time-series based visualization, such as a line or bar chart, may be selected. Subsets of the ingested data in the population coverage ranges are ranked and mapped to select a context recommendation that is included in the selected visualization.

The techniques described herein improve the functioning of a computer and improve the technical field of data processing by generating useful contextualized visualizations derived from processing large amounts of data from a variety of data sources. The contextualized visualizations provide meaningful context and show relationships between the data that enhances the value of the data and the computing environment that provides the contextualized visualizations. These techniques further provide efficiency advantages because they allow the contextual visualizations to re-use rules that were generated for providing other contextual visualizations. For example, a user may input that a scatter plot visualization should be generated for three-dimensional data, and this rule may be re-used for generating future visualizations, resulting in preserving processing resources by re-using existing rules. Moreover, the technology itself is improved by the inclusion of the sophisticated data analysis techniques described herein, that allow a computing device to provide useful data analysis results that would not have been provided without these techniques. Of course, it is understood that these features and advantages are shared among the various examples herein and that no one feature or advantage is required for any particular embodiment.

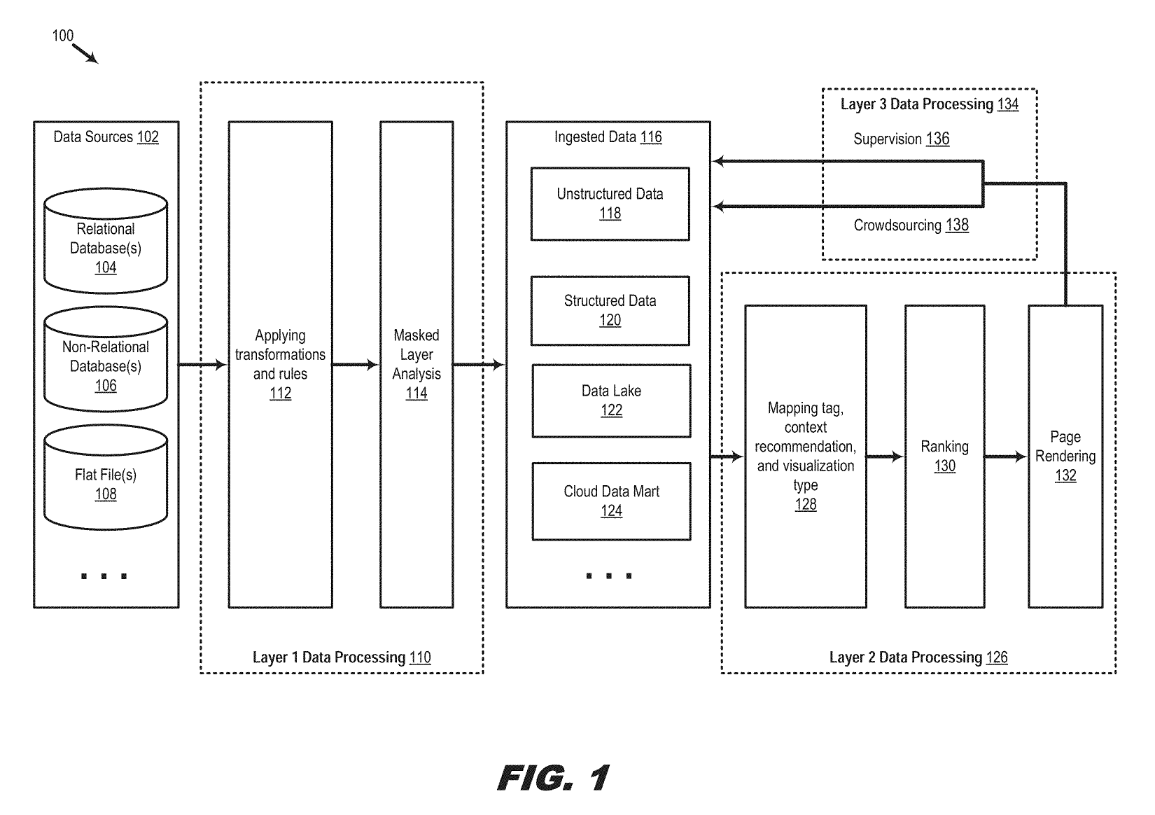

FIG. 1 illustrates is a system diagram illustrating a system 100 that implements a contextual engine for data analytics, in accordance with various examples of the present disclosure. The system 100 is implemented by one or more computing devices structured with hardware and software that include at least one non-transitory computer readable memory and one or more processors. In some examples, a computing device includes a plurality of computing devices that are communicatively coupled via a network to perform the operations described herein.

The system 100 includes one or more data sources 102. The data sources 102 may include a variety of homogeneous or heterogeneous data formats including relational databases 104 (e.g., SQL-derivatives, and so forth), non-relational databases 106 (e.g., JSON objects, and so forth), flat files 108 (e.g., text documents and so forth), and or other types of data sources. These data sources may include various types of data. For example, the data sources can include databases/repositories of contracts, procurements, orders, competitors, retailers, customers, as well as emails, attitudinal data including data captured via surveys, behavior data relating to Web browsing, click-through data, the Web, various social networks, among others.

One approach of using the system of FIG. 1 is to use hypothesis based development. The method can include developing multiple hypotheses. For hypothesis based development, transactional data, such as orders, has high potential to provide value. For a certain system, a hypothesis can indicate that a number of orders processed informs marketing. Another hypothesis can indicate that a location of orders informs future opportunities. Another hypothesis can indicate that cross sell opportunities may be apparent with order industry. Another hypothesis can indicate that email open/CTR rate predictions are possible to inform marketing. Another hypothesis can indicate that contracts may inform sales tactics through an N-gram.

The data from the data sources is processed via layer 1 data processing module 110 that includes hardware and/or software to access the data from the data sources 102 and join and parse the data from the data sources that are relevant to the hypothesis. For example, if the hypothesis relates to transaction activities of users, data sources that contain transactional data are joined and queried. In some examples, data sources are selected for joining based on user inputs and the identifiers of the selected data sources are stored in memory so that a computing device may select them in the future to validate similar hypotheses. For example, a user may select transactional databases for sales-related hypotheses and select user browsing history data for clickstream-related hypotheses. These are merely some examples of data sources that may be selected for joining and querying operations, and in other instances other data sources may be joined and queried.

The layer 1 data processing module 110 applies transformations and rules 112 to the retrieved data from the data sources 102 to structure the data in a particular format, such as to structure the format of the data (e.g., text from raw data) and/or to standardize the data. In this way, the data is transformed to a first format that may be used for further processing. After applying transformations and rules 112 to the data from the data sources 102, the layer 1 data processing module 110 performs masked layer analysis 114 to the transformed data. In the present example, the masked layer analysis 114 includes performing a double or triple binomial distribution analysis corresponding to the transformed data.

After performing the masked layer analysis 114, the data from the data sources 102 that is processed by the layer 1 data processing module 110 is stored as ingested data 116 in various formats, including unstructured data 118, structured data 120 (and/or semi-structured data), a data lake 122 (e.g., System Source DB section), and/or cloud data mart 124. For example, a cloud data mart 124 can be implemented via a cloud, and can be used to store data for a specific business unit. A data lake 122 can store data using a flat architecture. The ingested data 116 can be stored using various data repositories (e.g., a hierarchical data warehouse) in addition to or instead of those discussed.

In some examples, the ingested data 116 is stored at structured data 120 in a key-value pair format, including an identifier (key) and a text value corresponding to the key that includes a subset of the ingested data 116. The text values may include, for example, tags, context recommendations, and visualization types that are generated by the masked layer analysis 114 regarding the data. In some examples, each text value for a tag, context recommendation, or visualization type is associated with a corresponding key that is used to organize the text value within a database data source. Tags, visualization types, and context recommendations are described in further detail below.

In more detail regarding the visualization type, the visualization type includes an indicator of a type of chart or other visual display that shows a relationship between the data output by the masked layer analysis 114. For example, the visualization type may be a bar chart that shows a bar corresponding to each number of orders that are graphed along an x-axis of a coordinate plane relative to an amount of customers that are graphed along a y-axis of a coordinate plane. Various visualization types may be included, such as bar charts, scatter plots, line chart, pie charts, area charts, and so forth.

In more detail regarding the tag, the tag provides a textual description corresponding to the hypothesis. For example, if the hypothesis is that a number of orders processed informs marketing, the tag may be “Number of Orders,” or other text that describes the hypothesis. The tag also describes what is shown by data that is displayed in a generated visualization (e.g., having one of the visualization types described above). Generally, tags provide labels for generated visualizations that help a user understand what is depicted.

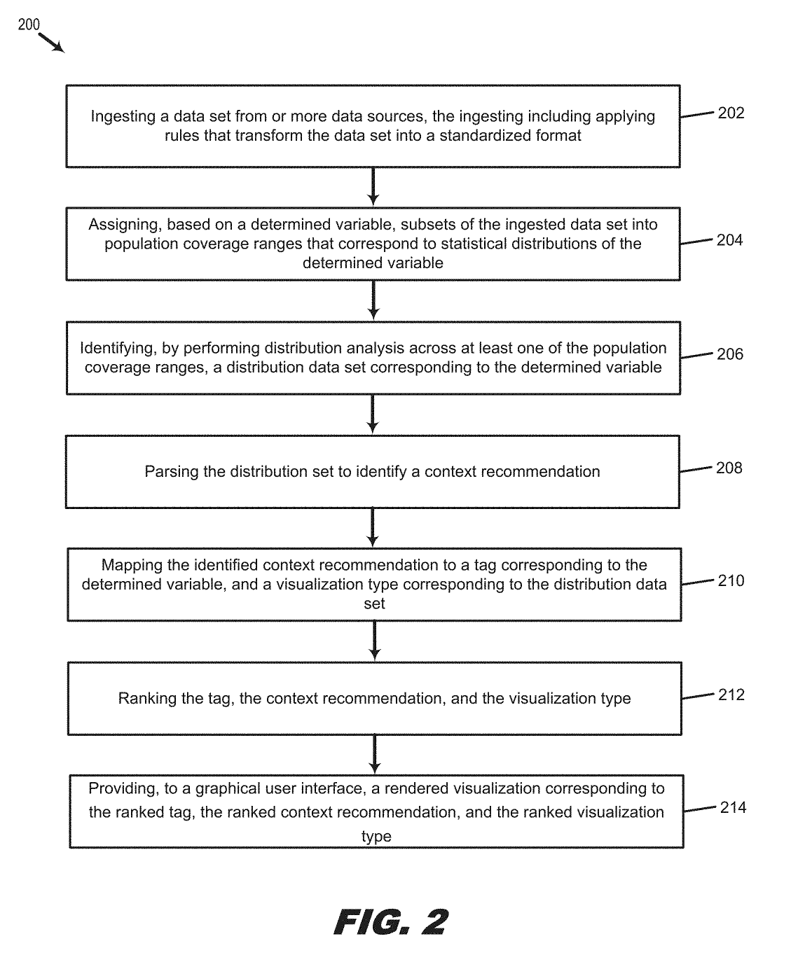

In more detail regarding the context recommendations, context recommendations are generated by performing the masked layer analysis 114 to indicate high propensity variables regarding a hypothesis, to identify a recommendation for making an improvement. For example, the masked layer analysis 114 may indicate that particular types of marketing greatly affect the number of orders (e.g., the indicated types of marketing are the high propensity variables). In this example, a context recommendation may be generated to increase spend on those particular types of marketing, to thereby improve the number of orders. Context recommendations and their generation is discussed in further detail with respect to FIG. 2.

The ingested data 116 is processed by a layer 2 data processing module 126 that includes hardware and/or software to input the ingested data 116. The layer 2 processing module 126 parses the ingested data 116 to map tags to the relevant context recommendations, and visualizations at block 128. The mapping is described in further detail with respect to FIG. 2. Each tag may be mapped to multiple visualization types (indicating that different visualizations would be effective for conveying the determined relationships between the data) and multiple context recommendations (indicating that multiple observations or recommendations have been determined regarding a hypothesis).

At block 130, the tags, visualization types, and context recommendations are assigned a ranking that indicates their effectiveness for conveying information to users. In some examples, the rankings are assigned based on pre-configured criteria (e.g., context recommendations based on a high-propensity variable may be ranked more highly than a variable determined to have a lower propensity). In other examples, rankings may be set to a pre-configured default ranking, and then modified later based on supervision 136 and/or crowdsourcing 138. The rankings may further be modified based on the results of merchants and/or other users following the context recommendations. For example, context recommendations that are followed and improve results may be assigned higher rankings, whereas context recommendations that are not followed, or that do not improve results may be assigned lower rankings. Rankings are described in further detail with respect to FIG. 2.

At block 132, a page is rendered that provides a visualization corresponding to the visualization type (e.g., a bar chart is generated for a bar chart type visualization, a scatter plot is generated for a scatter plot type visualization, and so forth). The page may be a web page or other display that is presented by an application. The rendered page includes the tag as a title for the visualization. The rendered page also includes visualizations and/or text corresponding to the context recommendations. For example, context recommendations may be included in the rendered page using graphical elements such as arrows or other indicators that identify data points (e.g., a bar of a bar graph, a point in a scatter plot, or other aspect) of the visualization and presents textual information regarding a generated observation regarding the data points and/or a recommended strategy to improve those data points.

Updates are applied to the tags, context recommendations, and visualization types by applying a layer 3 data processing module 134 that includes hardware and/or software. The layer 3 data processing module 134 includes a supervision 136 element that processes input from a supervisor to modify rankings corresponding to the tags, context recommendations, and visualization types. For example, the supervision 136 element provides the ability to take action on the rendered page by replacing a particular context recommendation or visualization type with another selected context recommendation or visualization type. For example, a supervisor may remove the context recommendation, such that the masked layer analysis 114 can generate another context recommendation and/or so that the context recommendation can be given a lower rank, thus allowing for a higher ranked context recommendation to be displayed in a generated visualization instead.

The crowdsourcing 138 element provides the ability for users to like or dislike a generated context recommendation. These likes/dislikes may be taken into account to modify the rankings assigned to the tags, context recommendations, and visualization types. In some examples, the crowdsourcing 138 element analyzes the users to assign them a behavioral profile, which may be used to customize visualizations for particular users.

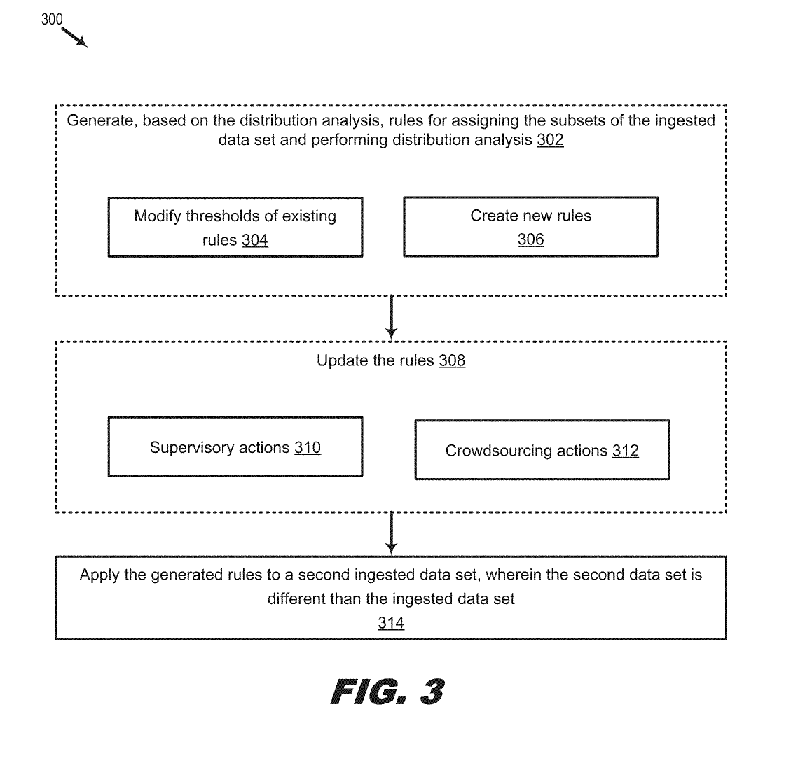

FIG. 2 is a flow diagram illustrating a method 200 for providing contextual data analytics. In some examples, the method is performed by executing computer-readable instructions that are stored in a non-transitory memory using one or more processors. The non-transitory memory and processors may be provided by, for example, the system 100 described with respect to FIG. 1. Additional steps may be provided before, during, and after the steps of method 200, and some of the steps described may be replaced, eliminated and/or re-ordered for other embodiments of the method 200. Method 200 may be performed, for example, in combination with the steps of method 300 as described with respect to FIG. 3.

At action 202, a layer 1 data processing module 110 of a computing device ingests a data set from one or more data sources that include transactional, behavioral, and/or attitudinal (e.g. survey) data. In the present example, the layer 1 data processing module 110 ingests a data set by determining statistical significances corresponding to data set, identifying errors corresponding to the data set, and normalizing the data set, thereby transforming the data set to a first format.

In some examples, the ingesting includes applying rules that transform the data set into a standardized format, such as by standardizing rows in one or more database tables and transforming the data contained in the tables to a same format. Depending on the data, different data preparation methods can be used to structure the data. For structured data, the method can access the data and perform various data preparations, such as standardizing rows or record labels for data stored by a certain database. Use of row standardization can be used to ensure that every row has the same number of fields and/or the fields are in a certain order. For a standard number of fields, the method can detect table rows that contain fewer than the maximum number of fields, and these detected table rows can be appended with null and/or other values. An example of an implementation to standardize rows is to use a function that takes a single character vector as input and assigns the values in a certain order.

In some examples, the standardizing includes correcting or discarding and/or excluding the accessed data. For example, data stored within the data sources may be standardized to a common format, such as by modifying various formats of phone number or address strings to comply with a common format or to discard/exclude data that do not comply with the standard format. For example, for address data, data not complying with a number followed by a street can be excluded and/or discarded. These are merely examples of various standardizations that may be performed by applying transformations and rules to the data.

In some examples, the standardizing includes applying of transformations and rules to identify particular transactions, identifiers (e.g., business names or names of people, email addresses, addresses, phone numbers, and so forth) and recognize activities corresponding to those identifiers. For example, a rule may parse a name from a database table and recognize one or more columns or rows of the database table as including transactions corresponding to the parsed name. In other examples, rules may be applied to associate demographic information with the identifiers.

At action 204, the layer 1 data processing module 110 assigns, based on a determined variable, subsets of the ingested data set into population coverage ranges that correspond to statistical distributions of the determined variable. In the present example, the layer 1 data processing module 110 determines the variable by parsing it from a hypothesis that is provided by a user, or retrieves the variable from a data structure. This determined variable is used as a dependent variable to perform statistical analysis to identify a highest propensity variable with respect to the determined variable.

For example, the hypothesis may be that marketing yields greater amount of purchases from high-spenders, and the determined variable from this hypothesis may be the amount of purchases. The computing device applies a random statistical model to the data to determine a highest propensity variable in the ingested data that has a highest probability to influence the determined variable (e.g., amount of purchases). For example, if the data from the data sources identifies men who live in the United States, are athletes, and high-spenders (e.g., men who spend over a predetermined amount over a predetermined period of time), the random statistical model determines which of those features has the highest propensity to the amount of purchases. For example, the high-spenders variable may be determined to be the variable that has the highest propensity to the amount of purchases. In some examples, the highest propensity variable is determined by applying a random statistical model to the ingested data set.

As merely one example, a binomial probability statistical analysis rule, such as the rule shown below, may be applied to identify a highest propensity variable for the determined variable:

$$P ( x ) = \frac{n !}{x ! ( n - x ) !} * {q}^{n - x} e * 3 x$$

In the above rule, P(x) represents a probability of x amount of successes, x represents a number of successes, q represents the probability of failure, and n represents the number of trials. Accordingly, a variable that has a highest P(x) probability value may be identified as a highest propensity variable. In other examples, other statistical analysis techniques may be used to determine the highest propensity variable.

In the present example, the highest propensity variable is determined by a statistical mode assigning a number (such as a probability) to the variable that is greater than the numbers assigned to one or more other variables. Per the above example, if the high-spender variable is determined to be the high propensity variable, then the high-spender variable would have a higher probability of effecting the amount of purchases variable than the other variables that were considered (e.g., gender or athlete status).

Next, the highest propensity variable is used to create population bins corresponding to population coverage ranges (e.g., one bin per population coverage ranges), and to assign and/or store subsets of the ingested data in their appropriate bins. With respect to the previously discussed example, assigning data to population coverage ranges may include performing binomial distribution analysis on the ingested data set, based on the high-spender variable, to distribute subsets of the ingested data set into the population coverage ranges, with a low population coverage range including a subset of data corresponding to low-spenders (e.g., users who spend below a predetermined amount over a predetermined period of time) and a high population coverage range including a subset of data corresponding to high-spenders. This is merely one example, and in other examples, the determined variable, highest propensity variable, and population coverage ranges may be generated differently to correspond to other hypotheses.

At action 206, the layer 1 data processing module 110 identifies, by performing distribution analysis across at least one of the population coverage ranges, a distribution data set corresponding to the determined variable. In the present example, the data that falls into the population coverage range at a top or bottom of the distribution curve is selected for distribution analysis. For example, with respect to the “amount of purchases” example discussed above, the subset of data in the population coverage range corresponding to the high-spenders (and/or the low spenders) may be selected for distribution analysis. The distribution analysis that is performed on the selected population coverage range may include performing binomial probability statistical analysis, such as by using the rule described above with respect to action 204. Regarding the “high spender” example discussed previously, the distribution analysis across the selected high spender population coverage range may indicate, for example, that the amount of marketing had the biggest impact on the amount of purchases made by the high spenders. This is merely one example, and in other examples the determined variable, highest propensity variable, distribution analysis may be different and yield different results.

At action 208, the layer 1 data processing module 110 parses the data in the distribution set to identify a context recommendation. In the present example, this parsing includes applying rules to the data to provide one or more context recommendations. Regarding the “high spender” example discussed previously, the parsing may identify, for example, that marketing had the biggest impact on the high spenders to thereby generate a context recommendation to increase marketing to that population. One or more such context recommendations are identified.

At action 210, a layer 2 data processing module 126 of the computing device maps the identified context recommendation to a tag corresponding to the determined variable, and a visualization type corresponding to the distribution data set. In more detail, the context recommendation determined at action 208 is mapped to a tag (e.g., in the amount example, the numbers of orders processed), and to a visualization that is determined based on the type of data (e.g., a bar chart for numbers of orders). Visualization types are selected based on rules that are applied to the data. For instance, a rule may be to apply a time-series visualization (e.g., a line or bar chart) for time data, a scatter plot for three-dimensional data, and a bar chart for clickstream data. Accordingly, one or more tags, visualizations, and context recommendations may be generated and mapped.

The below table provides additional examples of the parsing of the data and applying rules to generate context recommendations and visualizations.

TABLE 1

| | | Visual- | | |
|---|---|---|---|---|
| Rule | | ization | Content | Context |
| Summary | Rule | Type | Observation | Recommendation |
| Low | 92% of | Frequency | XX % | Recommend |
| Orders | customers | Graph | of the | that merchant |
| | process- | | customers | create a |
| | ing <=1 | | are not | loyalty program |
| | Order | | repeat | or increase |
| | | | buyers. | marketing. |
| High | If >1 | Frequency | XX % | The customers |
| Orders | transaction | Graph | of the | are loyal so |
| | is processed | | customers | to increase |
| | by 40% | | are repeat | the amount of |
| | of the | | buyers | orders, provide |
| | merchant's | | | promotions and |
| | customers | | | market to new |
| | | | | consumers rather |
| | | | | than spending |
| | | | | time on existing |
| | | | | customers. |
| Low | If 20% of | Monetary | The order | Recommend in |
| Spend | merchants | Graph | value from | cart promotion |
| | and 85% of | | XX % of the | to increase |
| | customers | | customers | [Monetary |
| | are spend- | | is $100 | amount in] |
| | ing <$100 | | or less. | shopping cart |
| | | | | by providing |
| | | | | free Shipping |
| | | | | for bundled |
| | | | | products. |

The above table shows a few examples of rules that may be applied to the parsed data to generate appropriate context recommendations and visualization types. In the present example, the applying of the rules includes applying the thresholds in the rules to determine context representations. For example, in the above table, the “Low Spend” rule includes the “20% of merchants,” “85% of customers,” and “<$100” thresholds that are applied to the data to identify whether the rule is met, thus causing the “monetary graph” visualization type to be applied, and the “Recommend in cart promotion . . . ” context recommendation to be applied to data that meets those thresholds.

In some examples, the layer 2 data processing module 126 applies visualization type rules that determine data type, a numerosity, and a dimensionality corresponding to the distribution data set, and selects an appropriate visualization type based on the determined data type, numerosity, and dimensionality. In some examples, the visualization type is one of a relationship visualization type, a categorical visualization type, or a frequency visualization type. For example, if the data type is a time series data type or clickstream data type, then the applied rule may select a bar chart visualization type. In other examples, if the dimensionality of the distribution data type is three-dimensional, then a scatter plot may be selected as the visualization type.

For example, in the above table, the “Low Spend” rule includes the “20% of merchants,” “85% of customers,” and “<$100” thresholds that are applied to the data to identify whether the rule is met, thus causing the “monetary graph” visualization type to be applied, and the “Recommend in cart promotion . . . ” context recommendation to be applied.

At action 212, the layer 2 data processing module 126 ranks the tag, the context recommendation, and the visualization type. In the present example, the tag, context recommendation, and visualization type are ranked based on behaviors of users. For example, if users do not take the action recommended by a context recommendation, that context recommendation (and in some instances, the corresponding tag and visualization type) may be assigned a lower ranking. Similarly, if the user performs the action recommended by the context recommendation, and the action does not result in improved performance, the context recommendation (and in some instances, the corresponding tag and visualization type) may be assigned a lower ranking.

As an example of reducing a ranking, if a tag, visualization type, and context recommendation are provided according to the “Low Spend” rule in Table 1, the layer 2 processing module 126 parses the ingested data to identify whether the “Recommend in cart promotion . . . ” context recommendation resulted in causing the “20% of merchants” or “85% of customers” to increase spending above the “<$100” threshold. If not, then the tag, visualization type, and context recommendation may have their rank decreased.

On the other hand, tags, context recommendations, and visualization types may have their rankings increased based on positive actions, such as merchants or customers adopting the recommendations and the ingested data showing that a positive result is achieved. For example, if users take the action recommended by a context recommendation, that context recommendation (and in some instances, the corresponding tag and visualization type) may be assigned a higher ranking. Similarly, if the user performs the action recommended by the context recommendation, and the action results in improved performance, the context recommendation (and in some instances, the corresponding tag and visualization type) may be assigned a higher ranking.

As an example of increasing a ranking, if a tag, visualization type, and context recommendation are provided according to the “Low Spend” rule in Table 1, the layer 2 processing module 126 parses the data to identify whether the “Recommend in cart promotion . . . ” context recommendation resulted in causing the “20% of merchants” or “85% of customers” to increase spending above the “<$100” threshold. If so, then the tag, visualization type, and context recommendation may have their rank increased.

Other actions that may cause a ranking to be reduced include users spending greater than a threshold amount of time on a page viewing a tag, visualization type, and context recommendation without taking action, which may indicate that the user is confused. In some examples, the amount of time is measured based on the user's session time. On the other hand, users spending less than a threshold amount of time on a page (as measured by a session time that is below the threshold), may indicate that the users easily understand the data, and that the ranking should be increased for the tag, visualization type, and context recommendation.

A default tag, context recommendation, and visualization type may be selected if there is no data yet available to perform the ranking.

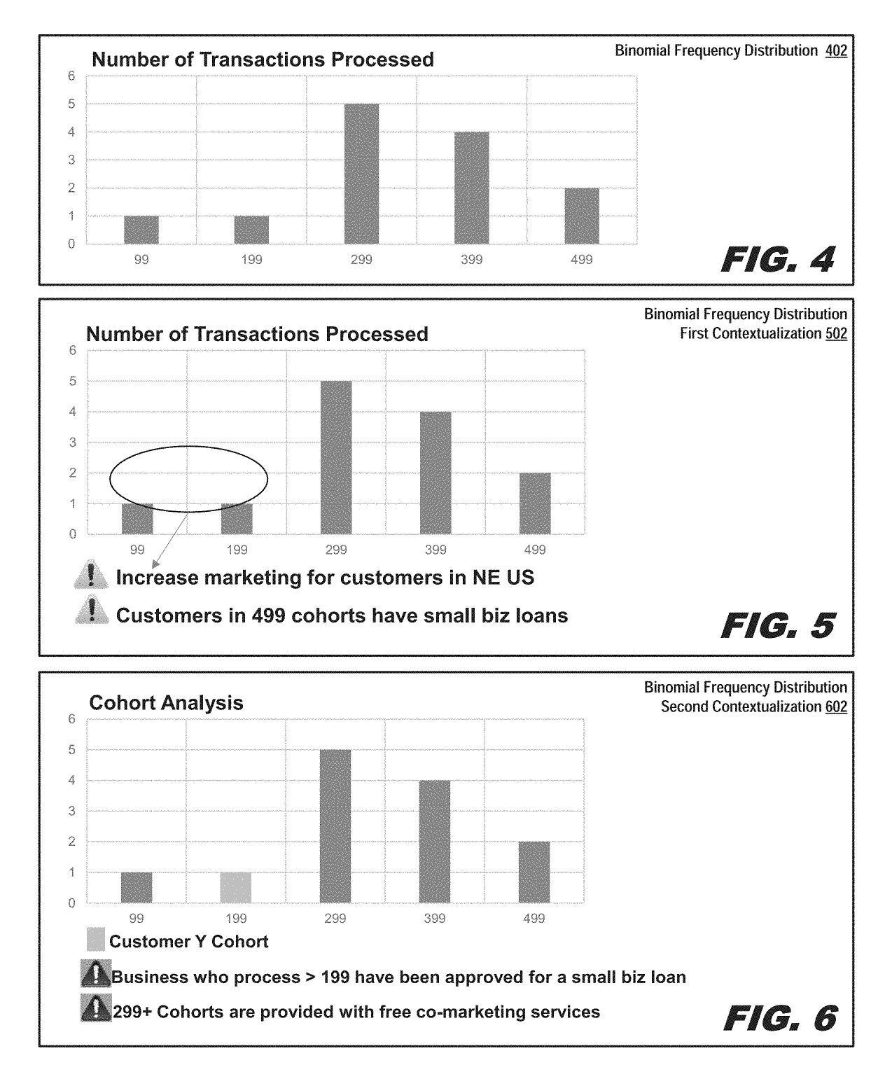

At action 214, the layer 2 data processing module 126 provides, to a graphical user interface, a rendered visualization corresponding to the ranked tag, the ranked context recommendation, and the ranked visualization type. In more detail, the type of visualization is applied to generate a corresponding visualization for displaying the data. In the example above, a bar chart may be generated to show numbers of orders processed. This bar chart may then be rendered on a user's display with the tag (e.g., numbers of orders) included in the chart to provide the user with context as to what the chart is showing, the chart further including the context recommendation (e.g., that marketing spend should be increased for the population coverage ranges at the low number of transactions portion of the bar chart). Example rendered visualizations are illustrated in FIGS. 4, 5, and 6.

FIG. 3 is a flow diagram illustrating a method 300 for updating and applying context recommendation rules. In some examples, the method is performed by executing computer-readable instructions that are stored in a non-transitory memory using one or more processors. The non-transitory memory and processors may be provided by, for example, the system 100 described with respect to FIG. 1. Additional steps may be provided before, during, and after the steps of method 300, and some of the steps described may be replaced, eliminated and/or re-ordered for other embodiments of the method 300. Method 300 may be performed, for example, in combination with the steps of method 200 as described with respect to FIG. 2.

At action 302, the masked layer analysis 114 portion of the layer one data processing module 110 and/or the layer 3 data processing module 134 generates rules for assigning subsets of the data set for assigning the subsets of the ingested data set and performing distribution analysis. In the present example, at action 304 the thresholds in existing rules are modified and at action 306 further rules are created based on the statistical analysis described above with respect to action 204.

As an example of modifying thresholds in existing rules at action 304, the “Low Spend” rule in Table 1 indicates that “20% of merchants and 85% of customers are spending <$100.” If the percentages of merchants or customers change (as identified from updated ingested data), these thresholds in the rules may be modified to reflect the current data. For example, if 19% of merchants are identified as spending less than $100, then the “20% of merchants” percentage in the rule may be reduced to “19% of merchants.” Similarly, thresholds may be increased to take into account updated ingested data that shows increases.

As an example of generating a new rule at action 306, high propensity variables are identified as described with respect to action 204. For example, the amount of time that a user spends on a page (e.g., as measured by a session time) may be determined to be a high propensity variable with respect to whether the user makes a purchase. Distribution analysis may further identify a threshold amount of time at which a purchase is more likely to be made. Further, the distribution analysis may identify, based on analysis of merchant data, page features that cause users to spend more time on a web page. Accordingly, a rule may be dynamically created that provides a context recommendation to implement the identified page features if users are identified as spending below the identified threshold amount of time on the page.

At action 308, the layer 3 data processing module 134 applies supervisory actions 310 and/or crowdsourcing actions 312 to modify the generated rules and/or create new rules. As an example of a supervisory action 310, a supervisor may review outcomes corresponding to particular rules and select rules for deletion. For example, the supervisor may identify that particular context recommendations are not followed by users (or followed below a particular threshold), and therefore the rule for generating the context recommendation is not useful and should be removed or given a lower ranking. The supervisor may similarly identify that a rule yields a context recommendation that is followed above a threshold amount of time, and therefore the rule should be assigned a higher ranking. In some examples, the supervisor provides input regarding the rules via a graphical user interface. In other examples, the supervisor is provided via automation, such as by a software program that dynamically reviews and evaluates the rules based on monitored behavior data of merchants and other users.

The crowdsourcing actions 312 include actions by merchants or other users to identify particular rules as useful or not useful. In some examples, these actions may include the merchants or other users expressly identifying rules as useful or not useful in surveys or other attitudinal studies. In other examples, the usefulness of rules may be inferred based on whether the merchants or other users take the actions recommended by the context recommendations and/or based on other actions such as the amount of time that the users spend viewing the context recommendations. The layer 3 data processing module 134 may identify whether the users take the recommended actions based on updating the ingested data 116 by performing the data processing described with respect to the layer 1 data processing module 110, and parsing the updated ingested data 116 to identify any changes made by the users.

For example, if the context recommendation was to provide a promotional discount for bundling items in a shopping cart, the layer 3 data processing module 134 may parse transaction information corresponding to a merchant's online promotions to identify whether the promotional discount was applied for bundled items in users' shopping carts. Accordingly, based on this analysis, the layer 3 data processing module 134 can identify whether the context recommendation was followed, and thus whether the rule that provided the context recommendation should be kept or removed (or assigned an increased or decreased ranking relative to other rules).

At action 314, the layer 2 data processing module 126 applies the generated rules to a second ingested data set, wherein the second data set is different than the ingested data set. For example, the generated rules may be applied to a second hypothesis to generate a visualization including contextual recommendations corresponding to the second hypothesis. In this way, the efficiency of the system and process is improved by re-using previously generated rules, which are improved based on updating the ingested data 116. Accordingly, processing resources are preserved by dynamically adapting rules to take into account changes in the underlying data, such that these rules can be applied to other hypotheses and users.

FIG. 4 is a diagram illustrating an example binomial frequency distribution 402 generated for providing contextual data analytics. As illustrated by FIG. 4, a bar chart illustrates a number of transactions processed, with the x axis indicating the amount of customers and the y axis indicating frequency/count of transactions. For example, the chart indicates the 99 customers in a first group completed one transaction per customer, 199 customers in a second group completed one transaction per customer, 299 customers in another group completed five transactions per customer, and so forth.

Contextualization, which is an analysis layer, can be used to interpret data and/or review one or more graphs. For example, the contextualization can interpret one or more graphs used by a merchant to analyze customer behavior. A method can analyze the data, such as by shoppers pre and post purchase with a contextualized element based on distribution and supervision leading to machine learning contextualization. The shopper can be an identified person that accesses the merchant site.

The methods described herein can analyze the data presented in one or more graph(s). Based on this analysis, the method can develop custom rules, where each rule can map to a piece of content. The rules can be generated and used in a series, or can be used out of order. This piece of content can change based on supervision, such as where the user can indicate that the recommendation is good or bad (aka a recommendation rating). The method can store the result of the recommendation rating, and can compare the result against the next recommendation (e.g., upon a next time the user accesses the system), such that the same contextualized content is not presented again. Any tag placed on a retailer's site which has analytics can take advantage of the contextualized engine and insights after data ingestion.

FIG. 5 is a diagram illustrating an example binomial frequency distribution including a first contextualization 502 and FIG. 6 is a diagram illustrating an example binomial frequency distribution including a second contextualization 602. As illustrated by FIG. 5 and FIG. 6, contextual recommendations can be used to generate products for user consumption. In some embodiments, the customer insights that are generated can be descriptive, predictive, and personalized for the merchant. The customer insights can be predictive for a customer on a transaction by transaction basis. The system can perform customer aggregate cohort analysis to provide descriptive statistics on customer demographics. The system can generate predictions on next products use for the merchant. The insights can be used in servicing portals or separate insight/analytics portals.

In some embodiments, the system can capture fees for media material provided by the generated visualizations. These visualizations can provide helpful information for merchants, such as by displaying upward and downward trending items. Further, the system can perform market analysis on goods and services, and determine when merchants' product lines can be expanded, exploited, or are on a demise curve.

The system can perform merchant market analysis that includes ingestion of media (Twitter™, news feeds, more). Thus media ingestion can provide bites of data for merchants to determine when to stay in market and get out of market. The system can perform multivariate analysis on the data, such as the distribution analysis described herein, to determine types of products the merchant sells, media, PR activities. This functionality can be exposed to merchant systems via Application Program Interfaces (APIs). The system can further provide snippets of proof points based on text mining N-gram analysis and sentiment and the association with the user.

Thus, the system can analyze the data via product reviews, news watch, and social media, and/or any crowd sourced content to perform the supervision and crowdsourcing analysis described herein. Based on this analysis, as well as based on transactional level data about the merchant, as captured in the ingested data described herein, the system can predict market viability for the merchant. The system can make recommendations to start, stop, and/or continue certain strategies, including how certain product features affect sales.

It should be understood that the figures and the operations described herein are examples meant to aid in understanding embodiments and should not be used to limit embodiments or limit scope of the claims. Embodiments may perform additional operations, fewer operations, operations in a different order, operations in parallel, and some operations differently. For example, one or more elements, steps, or processes described with reference to the diagrams of the figures may be omitted, described in a different sequence, or combined as desired or appropriate.

As will be appreciated by one skilled in the art, aspects of the present disclosure may be embodied as a system, method, or computer program product. Accordingly, aspects of the present disclosure may take the form of an entirely hardware embodiment, a software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible and/or non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Computer program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The computer program code may execute (e.g., as compiled into computer program instructions) entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flow diagram illustrations and/or block diagrams of methods, apparatus (systems) and computer program products according to embodiments of the present disclosure. It will be understood that each block of the flow diagram illustrations and/or block diagrams, and combinations of blocks in the flow diagram illustrations and/or block diagrams, can be implemented by computer program instructions. These computer program instructions may be provided to a processor of a general purpose computer, special purpose computer, or other programmable data processing apparatus to produce a machine, such that the computer program instructions, which execute via the processor of the computer or other programmable data processing apparatus, create means for implementing the functions/acts specified in the flow diagrams and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flow diagrams and/or block diagram block or blocks.

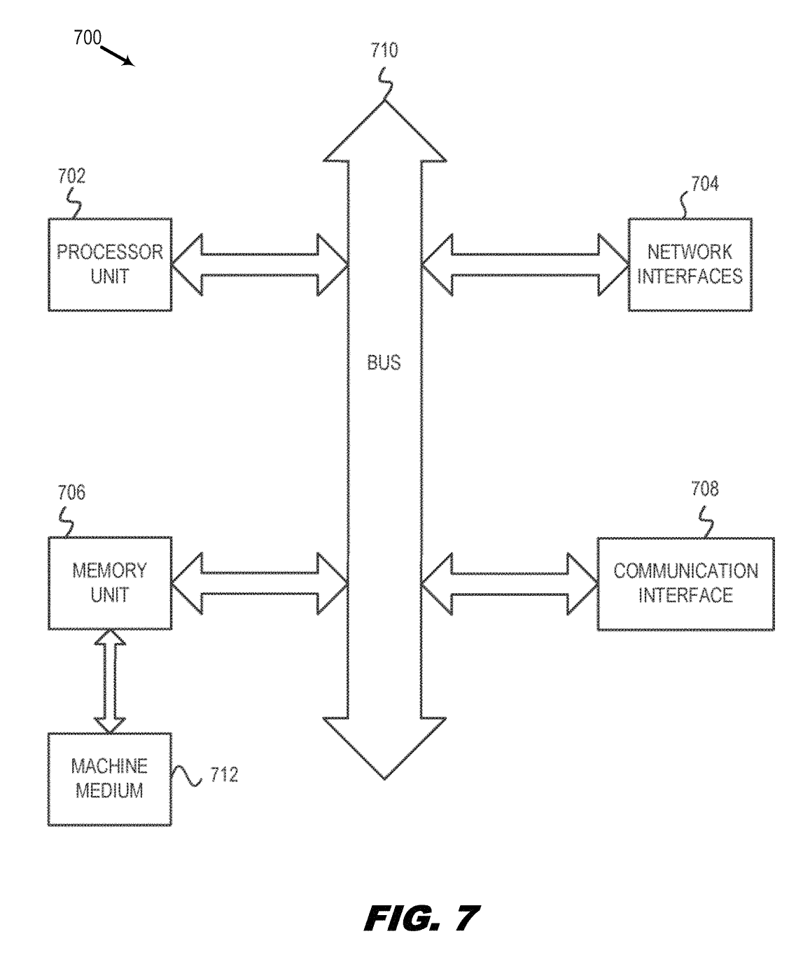

FIG. 7 is a block diagram of an exemplary embodiment of an electronic device 700 including a communication interface 708 for network communications. The electronic device can embody functionality to implement embodiments described in FIGS. 1-3 above. In some implementations, the electronic device 700 may be a laptop computer, a tablet computer, a mobile phone, a powerline communication device, a smart appliance (PDA), a server, and/or one or more another electronic systems. For example, a user device may be implemented using a mobile device, such as a mobile phone or a tablet computer. For example, a payment system may be implemented using one or more servers. The electronic device 700 can include a processor unit 702 (possibly including multiple processors, multiple cores, multiple nodes, and/or implementing multi-threading, etc.). The electronic device 700 can also include a memory unit 706. The memory unit 706 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 700 can also include the bus 710 (e.g., PCI, ISA, PCI-Express, HyperTransport®, InfiniBand®, NuBus, AHB, AXI, etc.), and network interfaces 704 can include wire-based interfaces (e.g., an Ethernet interface, a powerline communication interface, etc.). The communication interface 708 can include at least one of a wireless network interface (e.g., a WLAN interface, a Bluetooth interface, a WiMAX interface, a ZigBee interface, a Wireless USB interface, etc.). In some implementations, the electronic device 700 may support multiple network interfaces—each of which is configured to couple the electronic device 700 to a different communication network.

The memory unit 706 can embody functionality to implement embodiments described in FIGS. 1-3 above. Any one of these functionalities may be partially (or entirely) implemented in hardware and/or on the processor unit 702. For example, some functionality may be implemented with an application specific integrated circuit, in logic implemented in the processor unit 702, in a co-processor on a peripheral device or card, etc. Further, realizations may include fewer or additional components not illustrated in FIG. 6 (e.g., video cards, audio cards, additional network interfaces, peripheral devices, etc.). The processor unit 702, the memory unit 706, the network interface 704 and the communication interface 708 are coupled to the bus 710. Although illustrated as being coupled to the bus 710, the memory unit 706 may be coupled to the processor unit 702.

While the embodiments are described with reference to various implementations and exploitations, it will be understood that these embodiments are illustrative and that the scope of the present disclosure is not limited to them. In general, techniques for implementing contextual data analytics as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the present disclosure. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the present disclosure.

What is claimed is:

1. A system, comprising:
a non-transitory memory; and
one or more hardware processors coupled to the non-transitory memory and configured to read instructions from the non-transitory memory to cause the system to perform operations comprising:
ingesting a data set from or more data sources, the ingesting including applying rules that transform the data set into a first format;
assigning, based on a determined variable, subsets of the ingested data set into population coverage ranges that correspond to statistical distributions of the determined variable;
identifying, by performing distribution analysis across at least one of the population coverage ranges, a distribution data set corresponding to the determined variable;
parsing the distribution set to identify a context recommendation;
mapping the identified context recommendation to a tag corresponding to the determined variable, and a visualization type corresponding to the distribution data set;
ranking the tag, the context recommendation, and the visualization type; and
providing, to a graphical user interface, a rendered visualization corresponding to the ranked tag, the ranked context recommendation, and the ranked visualization type.

2. The system of claim 1, wherein the applying of the rules comprises determining statistical significances corresponding to the data set, identifying errors corresponding to the data set, and normalizing the data set.

3. The system of claim 1, wherein the assigning of the subsets of the ingested data set comprises:
distributing, based on the determined variable, the ingested data set into the population coverage ranges corresponding to a highest propensity variable that is determined by applying a random statistical model to the ingested data set.

4. The system of claim 1, the operations further comprising:
determining a data type, a numerosity, and a dimensionality corresponding to the distribution data set, wherein the determined data type includes at least one of a time series data type or a clickstream data type; and
assigning, based on the data type, the numerosity, and the dimensionality, a visualization type to the distribution data set, wherein the visualization type indicates at least one of a relationship visualization type, a categorical visualization type, or a frequency visualization type.

5. The system of claim 1, the operations further comprising updating, based on one or more supervisory actions, the context recommendation.

6. The system of claim 1, the operations further comprising updating, based on one or more crowdsourcing selections, the context recommendation.

7. The system of claim 1, the operations further comprising generating, based on the distribution analysis, rules for determining context recommendations.

8. The system of claim 7, the operations further comprising storing the generated rules; and applying the generated rules to a second ingested data set, wherein the second data set is different than the ingested data set.

9. A non-transitory machine-readable medium having stored thereon machine-readable instructions executable to cause a machine to perform operations comprising:
ingesting a data set from or more data sources, the ingesting including applying rules that standardize the data set;
assigning, based on a determined variable, the ingested data set into population coverage ranges that correspond to statistical distributions of the determined variable;
identifying, by performing distribution analysis across at least one of the population coverage ranges, a distribution data set corresponding to the determined variable;
parsing the distribution set to identify a context recommendation;
mapping the identified context recommendation to a tag corresponding to the determined variable, and a visualization type corresponding to the distribution data set;
ranking the tag, the context recommendation, and the visualization type; and
providing, to a graphical user interface, a rendered visualization corresponding to the ranked tag, the ranked context recommendation, and the ranked visualization type.

10. The non-transitory machine-readable medium of claim 9, wherein the applying of the rules comprises determining statistical significances corresponding to the data set, identifying errors corresponding to the data set, and normalizing the data set.

11. The non-transitory machine-readable medium of claim 9, wherein the assigning of the ingested data set comprises:
distributing, based on the determined variable, the ingested data set into the population coverage ranges corresponding to a highest propensity variable that is determined by applying a random statistical model to the ingested data set.

12. The non-transitory machine-readable medium of claim 9, the operations further comprising:
determining a data type, a numerosity, and a dimensionality corresponding to the distribution data set, wherein the determined data type includes at least one of a time series data type or a clickstream data type; and
assigning, based on the data type, the numerosity, and the dimensionality, a visualization type to the distribution data set, wherein the visualization type indicates at least one of a relationship visualization type, a categorical visualization type, or a frequency visualization type.

13. The non-transitory machine-readable medium of claim 9, the operations further comprising generating, based on the distribution analysis, rules for determining context recommendations.

14. The non-transitory machine-readable medium of claim 13, the operations further comprising storing the generated rules; and applying the generated rules to a second ingested data set, wherein the second data set is different than the ingested data set.

15. A method comprising:
transforming a data set into a first format;
assigning, based on a variable determined from a hypothesis provided by a user, subsets of the transformed data set into population coverage ranges that correspond to statistical distributions of the determined variable;
identifying, by performing distribution analysis across at least one of the population coverage ranges, a distribution data set corresponding to the determined variable;
parsing the distribution set to identify a context recommendation;
mapping the identified context recommendation to a tag corresponding to the determined variable, and a visualization type corresponding to the distribution data set;
ranking the tag, the context recommendation, and the visualization type; and
providing, to a graphical user interface, a rendered visualization corresponding to the ranked tag, the ranked context recommendation, and the ranked visualization type.

16. The method of claim 15, wherein the transforming of the data set comprises determining statistical significances corresponding to the data set, identifying errors corresponding to the data set, and normalizing the data set.

17. The method of claim 15, wherein the assigning of the subsets of the transformed data set comprises:
distributing, based on the determined variable, the transformed data set into the population coverage ranges corresponding to a highest propensity variable that is determined by applying a random statistical model to the ingested data set.

18. The method of claim 15, further comprising:
determining a data type, a numerosity, and a dimensionality corresponding to the distribution data set, wherein the determined data type includes at least one of a time series data type or a clickstream data type; and
assigning, based on the data type, the numerosity, and the dimensionality, a visualization type to the distribution data set, wherein the visualization type indicates at least one of a relationship visualization type, a categorical visualization type, or a frequency visualization type.

19. The method of claim 15, further comprising generating, based on the distribution analysis, rules for determining context recommendations.

20. The method of claim 19, further comprising storing the generated rules; and applying the generated rules to a second transformed data set, wherein the second transformed data set is different than the transformed data set.
